(19) United States
(12) Patent Application Publication
(10) Pub. No.: US 2023/0334913 A1
(43) Pub. Date: Oct. 19, 2023

(54) VEHICLE FLEET MANAGEMENT

(71) Applicant: Site Vantage, Inc., Westport, CT (US)

(72) Inventors: Shawn Bonnington, Trinity, FL (US); Adnan Aziz, Frisco, TX (US)

(21) Appl. No.: 17/723,162

(22) Filed: Apr. 18, 2022

(51) Int. Cl. G06K 9/62; G07C 5/00; G07C 5/08; G06N 20/00

(52) U.S. Cl. CPC G07C 5/006; G06K 9/6256; G06N 20/00; G07C 5/0816

(57) ABSTRACT

Systems and methods to determine whether a vehicle in a vehicle fleet is recommended to undergo maintenance, and to cause the vehicle to undergo maintenance. A plurality of vehicles in a vehicle fleet may be identified based on a type of part. Status data from a variety of data sources, including sensors included in each vehicle of the plurality of vehicles, is received for the plurality of vehicles. The status data is used to determine whether at least one vehicle of the plurality of vehicles is recommended to undergo maintenance. The at least one vehicle is caused to undergo maintenance as a result of the determination that it is recommended to undergo maintenance.

### TECHNICAL FIELD

The present disclosure relates generally to data communications, and more particularly, to utilizing sensor data to detect whether vehicle maintenance is recommended for vehicles in a fleet of vehicles and cause vehicles to undergo recommended maintenance.

### BACKGROUND

### Description of the Related Art

Vehicle fleets typically include a variety of vehicle types and a large number of vehicles that must be maintained. In many cases, each individual vehicle is manually inspected at predetermined times to determine whether the vehicle requires, or is recommended to undergo, maintenance. Some vehicle fleets attempt to predict when individual vehicles should undergo maintenance based on factors such as an individual vehicle’s mileage, the amount of time that the vehicle has been used, etc. These predictions, however, do not normally take into account the totality of the information that can affect vehicle maintenance. It is with respect to these and other considerations that the embodiments described herein have been made.

### BRIEF SUMMARY

Briefly described, embodiment are directed toward systems and methods of identifying whether vehicles in a vehicle fleet require, or are recommended to undergo, maintenance. The vehicle fleet may include vehicles of various types. Vehicles of a certain type may share similar or common parts or types of parts. The vehicles may include trucks, cars, construction equipment, or other vehicles.

Vehicle data describing a fleet of vehicles is received. The vehicle data may include data describing at least one type of part for each vehicle included in the fleet of vehicles. The vehicle data may include other data describing, identifying, etc., a plurality of vehicles included in the vehicle fleet, such as a type of a vehicle, a model of the vehicle, a manufacturer of the vehicle, part manufacturers for parts included in the vehicle, fluids used by the vehicle, the vehicle’s age, the vehicle’s location, an operator associated with the vehicle, or other data which may be used to identify or describe a vehicle.

A type of part that is common to a particular set of vehicles is identified. The type of part might be a standard type, such as wheels, tires, axles, windshield wipers, or it might be a type of part that is particularly unique for a vehicle, or it might be a type of part that is identified for some of or a portion of the vehicles included in the fleet of vehicles. A type of part that might be unique to some of the vehicles might include a load weight sensor, dump truck hydraulics, a grating blade, whether mounted on the front, middle or rear of the vehicle, a loading bucket or any other type of part that is common to a set of some of the vehicles. The type of part that is common to set of the vehicles is used to identify a portion of the plurality of vehicles from the fleet of vehicles. The plurality of vehicles may include vehicles that include the common type of part, vehicles that do not include the common type of part, vehicles that include parts similar to the common type of part, etc.

Vehicle status data (“status data”) is periodically obtained from the plurality of vehicles as well as third-party data repositories. The status data may be obtained from one or more sensors included in a vehicle. The third-party data repositories may include data repositories which contain data describing vehicles, vehicle types, vehicle parts, vehicle part types, fluids used by the vehicle, manufacturing data for vehicles or vehicle parts, recall data for vehicles or vehicle parts, inspection data for vehicles or vehicle parts, or other data related to a vehicle, its parts, or the fluids used by a vehicle. One or more fluids used by each vehicle in the plurality of vehicles are identified, and fluid dynamics data related to the one or more fluids is received.

The status data is used to determine whether at least one vehicle of the plurality of vehicles is recommended to undergo maintenance. Each vehicle that is recommended to undergo maintenance is automatically caused to undergo maintenance.

In some embodiments, the maintenance recommended for the vehicle is determined based on the status data. The maintenance recommended for the vehicle may include: replacing one or more parts or aspects of the vehicle; inspecting one or more parts or aspects of the vehicle; adjusting one or more parts or aspects of the vehicle; a firmware, software, or other update to a computer system included in the vehicle; or other types of maintenance which can be performed on a vehicle. In some embodiments, the recommended maintenance may be determined by applying the status data to a machine learning model which identifies the maintenance recommended for a vehicle based on the status data. In some embodiments, the recommended maintenance may be determined by performing statistical analysis on the status data and historical status data received before the current status data is received.

In some embodiments, the determination that a vehicle of the plurality of vehicles requires, or is recommended to undergo, maintenance is obtained by using a machine learning model trained to determine whether a vehicle requires, or is recommended to undergo, maintenance based on status data. In some embodiments, the determination that a vehicle of the plurality of vehicles requires, or is recommended to undergo, maintenance is obtained by performing statistical analysis on the status data and historical status data received before the current status data is received.

Embodiments described herein can improve the operation of vehicles, improve the length of time the vehicle can be used before being replaced, or improve other aspects of a vehicle fleet or task performed by the vehicle fleet. Additionally, the embodiments disclosed herein may improve the functioning of the vehicles, computer systems included in the vehicles, or other aspects of the vehicles or vehicle fleet, as a results of causing a vehicle to undergo maintenance. For example, causing a vehicle to undergo maintenance may include maintenance which results in an improvement of the functionality of a computer system associated with the vehicle or vehicle fleet.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1A illustrates a context diagram of an environment for using data obtained from various sources to determine whether a particular vehicle in a vehicle fleet requires, or is recommended to undergo, maintenance.

FIG. 1B is a context diagram of a non-limiting example of an environment, in accordance with embodiments described herein.

FIG. 2 is a context diagram of non-limiting embodiments of systems for receiving and utilizing vehicle status data to determine whether a vehicle is recommended to undergo maintenance.

FIG. 3 illustrates a logical flow diagram showing one embodiment of a process for determining whether one or more vehicles included in a vehicle fleet are recommended to undergo maintenance and causing the one or more vehicles to undergo maintenance.

FIG. 4 illustrates a logical flow diagram showing one embodiment of a process for identifying a plurality of vehicles within a fleet of vehicles.

FIG. 5 illustrates a logical flow diagram showing one embodiment of a process for obtaining status data for a vehicle.

FIG. 6 shows a system diagram that describes various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

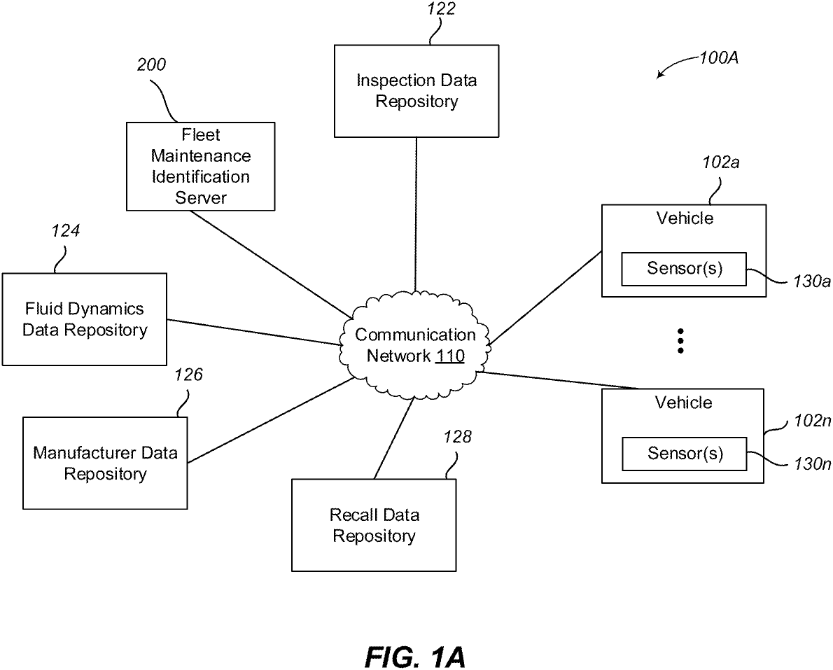

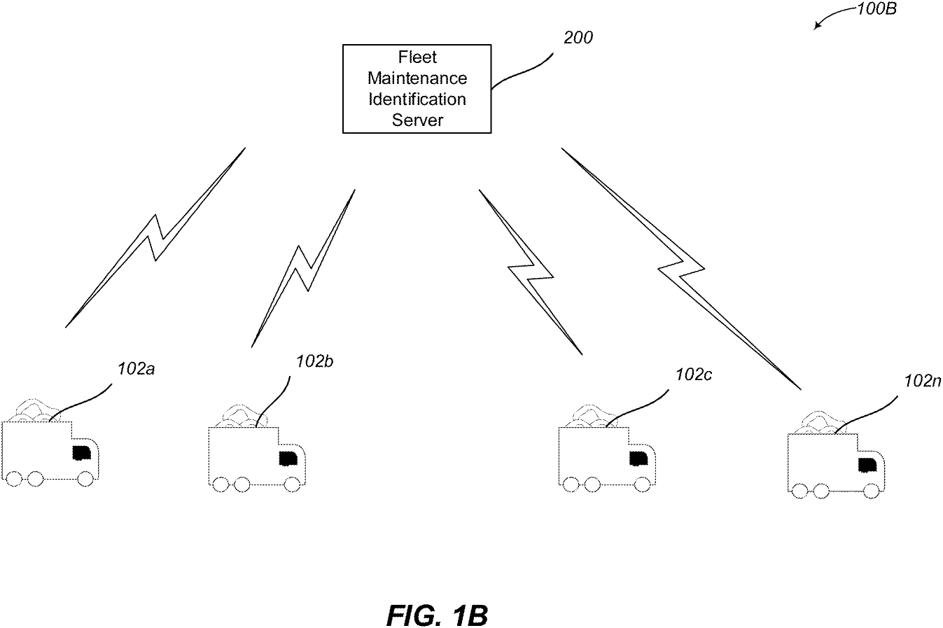

FIG. 1A illustrates a context diagram of an environment 100A for using data obtained from various sources to determine whether a particular vehicle in a vehicle fleet requires, or is recommended to undergo, maintenance. The environment 100A includes one or more vehicles 102a-102n, a network 110, an inspection data repository 122, a fluid dynamics data repository 124, a manufacturer data repository 126, a recall data repository 128, and a fleet maintenance identification server 200. Although FIG. 1A illustrates two vehicles 102a-102n, embodiments are not so limited. Rather, one or more vehicles 102a-102n may be included in the environment 100A.

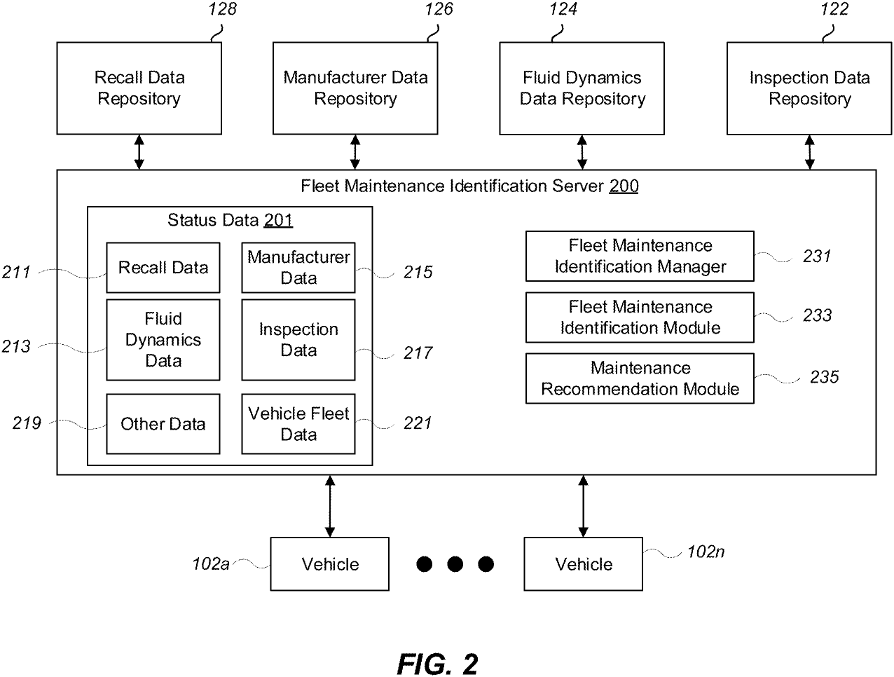

The fleet maintenance identification server 200 includes one or more computing devices that are configured to communicate with, cause to undergo maintenance, or otherwise manage vehicles 102a-102n, the inspection data repository 122, the fluid dynamics data repository 124, the manufacturer data repository 126, the recall data repository 128, or some combination thereof. The fleet maintenance identification server 200 is further described in relation to FIG. 2.

The vehicles 102a-102n include vehicles which are part of a fleet of vehicles (or “vehicle fleet”). In some embodiments, the vehicles 102a-102n are each in the same vehicle fleet. In some embodiments, the vehicles 102a-102n include vehicles from multiple vehicle fleets. Each of the vehicles 102a-102n have or include one or more sensors 130. The sensors 130 may be configured to obtain or capture data regarding a vehicle, parts associated with the vehicle, or other data associated with a vehicle. Examples of sensors 130 may include, but are not limited to, gyroscopes, accelerometers, onboard equipment computing systems, etc. In some embodiments, the data associated with the vehicle may be received or obtained from sources other than a sensor 130, such as manual inspections, automated inspections, self-reporting by an operator associated with the vehicle, or other sources of data used to describe a vehicle.

The inspection data repository 122 includes inspection data related to one or more vehicles. The inspection data may include any data obtained as a result of an inspection of a vehicle, such as an automated inspection, manual inspection, inspection reported by an operator associated with a vehicle, or other types of inspections. In some embodiments, the inspection data repository 122 includes inspection data for vehicles in a vehicle fleet, such as vehicles 102a-102n. In some embodiments, the inspection data repository 122 includes historical inspection data for vehicles or groups of vehicles.

The fluid dynamics data repository 124 includes fluid dynamics data related to one or more fluids used by one or more vehicles, such as the vehicles 102a-102n. The fluid dynamics data may include data related to the way that certain types of fluids affect certain types of vehicles or certain types of vehicle parts and other data related to the interaction between a vehicle or its parts and fluids which affect the vehicle.

The manufacturer data repository 126 includes manufacturer data related to one or more vehicles. The manufacturer data may include any data provided by, generated by, or associated with, a manufacturer for vehicles or vehicle parts produced by the manufacturer, such as user manuals, blueprints, part lists, design documents, or other data associated with a vehicle manufacturer.

The recall data repository 128 includes recall data related to one or more recalls for vehicles or vehicle parts. The recall data may include data regarding the issue which necessitated the recall, one or more solutions for the recall, the effects of the issues on the vehicle or vehicle part, or other data associated with a recall.

Although FIG. 1 illustrates the inspection data repository 122, the fluid dynamics data repository 124, the manufacturer data repository 126, the recall data repository 128 as being separate repositories, embodiments are not so limited. Rather, each of the repositories may be maintained, implemented, accessed, etc., as a single repository or multiple separate repositories.

Communication network 110 includes one or more wired or wireless networks in which data or communication messages are transmitted between various computing devices. The communication network 110 may be used or accessed by equipment or devices associated with the vehicle fleet, including the vehicles 102a-102n, the inspection data repository 122, the fluid dynamics data repository 124, the manufacturer data repository 126, the recall data repository 128, and any other data repositories, vehicles, or devices associated with the vehicle fleet. The vehicles 102a-102n, the inspection data repository 122, the fluid dynamics data repository 124, the manufacturer data repository 126, the recall data repository 128, and any other data repositories, vehicles, or devices associated with the vehicle fleet using or accessing the communication network 110 may be able to communicate with other data repositories, vehicles, or devices that are able to use or access the communication network 110.

FIG. 1B is a context diagram of a non-limiting example of an environment 100B, in accordance with embodiments described herein. The environment 100B includes the fleet maintenance identification server 200 and vehicles 102a-102d. Vehicles 102a-102d may be vehicles from the vehicles 102a-102n described in connection with FIG. 1A above. In the environment 100B vehicles 102a-102d each belong to the same vehicle fleet. In some embodiments, the vehicles 102a-102d belong to different vehicle fleets. In some embodiments, the vehicles 102a-102d belong to multiple vehicle fleets.

In the environment 100B the fleet maintenance identification server 200 communicates with each of the vehicles 102a-102d. The fleet maintenance identification server 200 receives data from each of the vehicles 102a-102d, such as sensor data. The fleet maintenance identification server 200 communicates with one or more third party repositories, such as the manufacturer data repository 126 or the fluid dynamics data repository 124 or the recall data repository 128 or the inspection data repository 122 in FIG. 1, to obtain other status data for each of the vehicles. The fleet maintenance identification server 200 determines whether at least one of the vehicles 102a-102d is recommended to undergo maintenance based on the data received from the vehicles 102a-102d and the data received from the third party repositories. The fleet maintenance identification server 200 causes the vehicles which are recommended to undergo maintenance to undergo the maintenance, such as by indicating to an operator associated with the vehicle that the vehicle is recommended to undergo maintenance, causing one or more parts to be ordered for the vehicle, scheduling a time maintenance for the vehicle at a location equipped to provide the recommended maintenance, or other methods of causing a vehicle to undergo maintenance.

FIG. 2 is a context diagram of non-limiting embodiments of systems for receiving and utilizing vehicle status data to determine whether a vehicle is recommended to undergo maintenance.

The context diagram of FIG. 2 includes one or more vehicles 102a-102n, an inspection data repository 122, a fluid dynamics data repository 124, a manufacturer data repository 126, and a recall data repository 128, which are generally discussed above in connection with FIGS. 1A and 1B. The context diagram of FIG. 2 additionally includes a fleet maintenance identification server 200. The fleet maintenance identification server 200 includes status data 201, a fleet maintenance identification manager 231, a fleet maintenance identification module 233, and a maintenance recommendation module 235. The fleet maintenance identification server 200 may be the fleet maintenance identification server 200 described above in connection with FIGS. 1A and 1B.

The status data 201 includes one or more of: recall data 211, fluid dynamics data 213, manufacturer data 215, inspection data 217, other data 219, or vehicle fleet data 221. The recall data 211 includes data received from one or more recall data repositories, such as the recall data repository 128. The fluid dynamics data 213 includes data received from one or more fluid dynamics data repositories, such as the fluid dynamics data repository 124. The manufacturer data 215 includes data received from one or more manufacturer data repositories, such as the manufacturer data repository 126. The inspection data 217 includes data received from one or more inspection data repositories, such as the inspection data repository 122. The vehicle fleet data 221 includes data received from vehicles included in one or more vehicle fleets, such as the vehicles 102a-102n. The other data 219 includes any other data which may be used by the fleet maintenance identification server 200, such as weather data, data describing one or more routes taken by vehicles in a vehicle fleet, data describing one or more geographic regions in which a vehicle operates, or other types of data which may be used to identify whether a vehicle is recommended to undergo maintenance.

The fleet maintenance identification manager 231 manages the reception of data, maintenance recommendations, and other data by the fleet maintenance identification server 200. The fleet maintenance identification manager 231 may additionally be configured to manage the transmission of data between the varying modules used by the fleet maintenance identification server 200.

The fleet maintenance identification module 233 is configured to use various types of data collected by the fleet maintenance identification server 200 to determine whether a vehicle is recommended to undergo maintenance. The fleet maintenance identification module 233 may use one or more of the recall data 211, fluid dynamics data 213, manufacturer data 215, inspection data 217, other data 219, or vehicle fleet data 221 (collectively “status data”) to determine whether a vehicle is recommended to undergo maintenance. In some embodiments, the fleet maintenance identification module 233 trains a machine learning model to determine whether a vehicle is recommended to undergo maintenance based on the status data.

In some embodiments, the fleet maintenance identification module 233 compares status data related to one vehicle or vehicle fleet to status data related to other vehicles or vehicle fleets in order to determine whether a vehicle is recommended to undergo maintenance. The fleet maintenance identification module 233 may compare the status data by using statistical analysis, artificial intelligence, machine learning models, or other tools or techniques which can be used to analyze data. For example, in some embodiments, the fleet maintenance identification module 233 may determine whether a vehicle is recommended to undergo maintenance by using a machine learning model trained to determine whether a vehicle is recommended to undergo maintenance based on status data. The machine learning model may be trained by using at least one of: recall data collected for a plurality of vehicles, recall data collected for a plurality of vehicle parts, fluid dynamics data collected for a plurality of vehicles, fluid dynamics data collected for a plurality of vehicle parts, manufacturer data collected for a plurality of vehicles, manufacturer data collected for a plurality of vehicle parts, inspection data collected for a plurality of vehicles, inspection data collected for a plurality of vehicle parts, vehicle fleet data collected for a plurality of vehicles, vehicle fleet data collected for a plurality of vehicle parts, other data collected for a plurality of vehicles or vehicle parts, or some combination thereof.

The maintenance recommendation module 235 is configured to determine the type of maintenance that a vehicle is recommended to undergo. The type of maintenance may include one or more of: maintenance performed by an operator of the vehicle; a repair or replacement for one or more parts for the vehicle; a software, hardware, or firmware update for one or more computer systems included in the vehicle; a change in one or more fluids used by the vehicle; scheduling an inspection or repair of one or more vehicle parts; or other types of maintenance which may be performed on a vehicle. The maintenance recommendation module 235 may compare status data of a vehicle recommended to undergo maintenance to status data of other vehicles that have received maintenance or other data received from one or more third party repositories to determine the type of maintenance that the vehicle is recommended to undergo. The maintenance recommendation module 235 may compare the status data by using statistical analysis, artificial intelligence, machine learning models, or other tools or techniques which can be used to analyze data. For example, the maintenance recommendation module 235 may determine the recommended maintenance by using a machine learning model trained based on status data to determine recommended maintenance for a vehicle. In some embodiments, the maintenance recommendation module 235 trains the machine learning model to determine the recommended maintenance based on status data. The machine learning model may be trained by using at least one of: recall data collected for a plurality of vehicles, recall data collected for a plurality of vehicle parts, fluid dynamics data collected for a plurality of vehicles, fluid dynamics data collected for a plurality of vehicle parts, manufacturer data collected for a plurality of vehicles, manufacturer data collected for a plurality of vehicle parts, inspection data collected for a plurality of vehicles, inspection data collected for a plurality of vehicle parts, vehicle fleet data collected for a plurality of vehicles, vehicle fleet data collected for a plurality of vehicle parts, or other data collected for a plurality of vehicles or vehicle parts.

Although FIG. 2 illustrates the recall data 211, fluid dynamics data 213, manufacturer data 215, inspection data 217, other data 219, and vehicle fleet data 221 as being stored separately, embodiments are not so limited. Rather, one or more databases may be utilized to store the recall data 211, fluid dynamics data 213, manufacturer data 215, inspection data 217, other data 219, and vehicle fleet data 221. Moreover, the recall data 211, fluid dynamics data 213, manufacturer data 215, inspection data 217, other data 219, and vehicle fleet data 221 may be stored on the fleet maintenance identification server 200, a separate or remote computing device (not illustrated), or some combination thereof. Furthermore, although FIG. 2 illustrates the fleet maintenance identification manager module 231, the fleet maintenance identification module 233, and maintenance recommendation module 235 as separate modules, embodiments are not so limited. Rather, one or a plurality of modules may perform the functionality of the fleet maintenance identification manager module 231, the fleet maintenance identification module 233, and maintenance recommendation module 235.

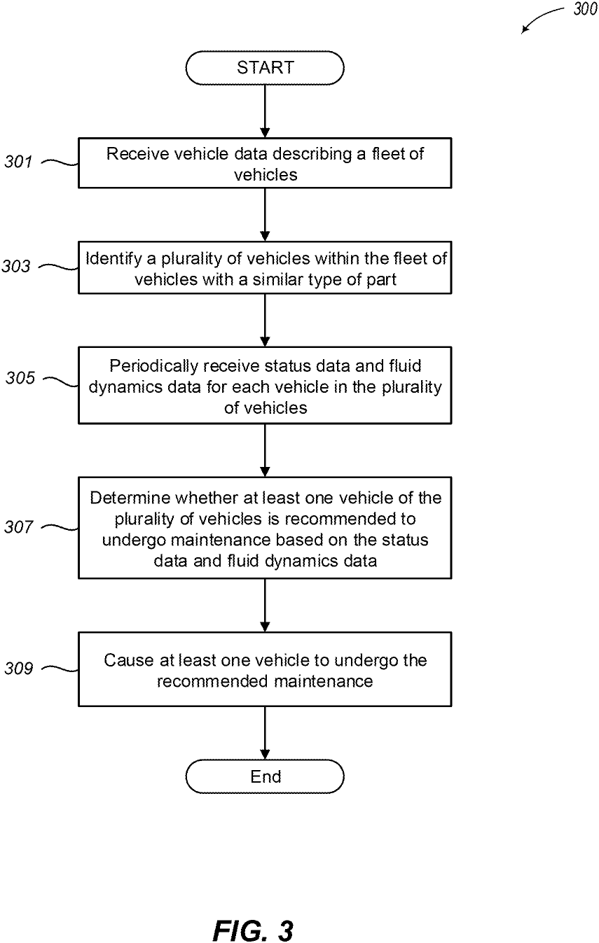

The operation of certain aspects will now be described with respect to FIGS. 3-5. In at least one of various embodiments, processes 300, 400, and 500 described in conjunction with FIGS. 3-5, respectively, may be executed via circuitry or implemented by or on one or more computing devices, such as the fleet maintenance identification server 200 (“the server”) in FIG. 2.

FIG. 3 illustrates a logical flow diagram showing one embodiment of a process 300 for determining whether one or more vehicles included in a vehicle fleet are recommended to undergo maintenance and causing the one or more vehicles to undergo maintenance.

After a start block, process 300 begins at block 301, where the server receives vehicle data describing a fleet of vehicles. The vehicle data may include vehicle fleet data, such as vehicle fleet data 221 described above in connection with FIG. 2. The vehicle data may include data describing one or more vehicles included in the vehicle fleet, including one or more parts included in each of the one or more vehicles. In some embodiments, the server is the fleet maintenance identification server 200, but the server may be a different server in other embodiments.

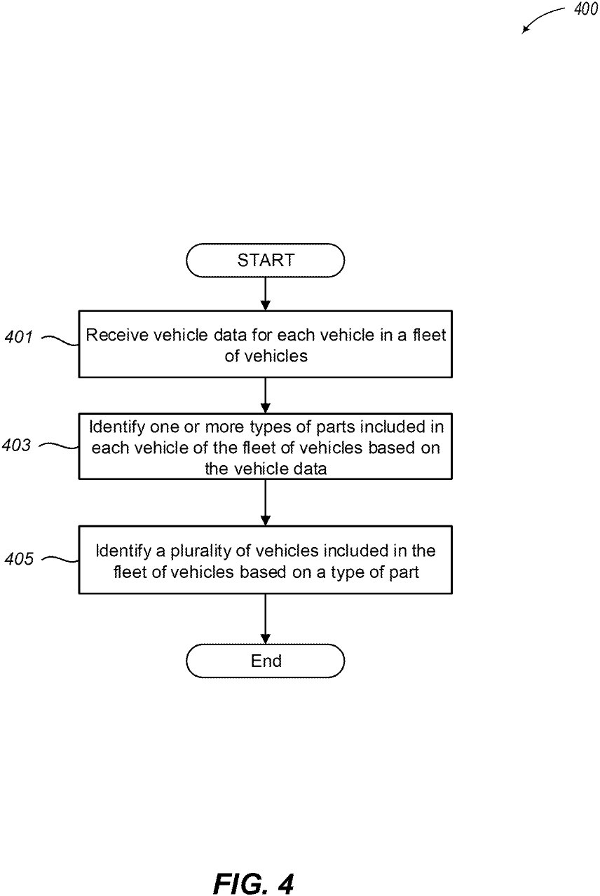

Process 300 proceeds next to block 303, where the server identifies a plurality of vehicles within the fleet of vehicles, which have a similar type of part. The similar type of part may be a common type of part that is included in a plurality of vehicles included in the fleet of vehicles. The similar type of part may be a common type of part that is not included in a plurality of vehicles included in the fleet of vehicles. The similar type of part may be a specific vehicle part or a class of vehicle parts. The server may identify the plurality of vehicles within the fleet of vehicles by using the process 400 described below in connection with FIG. 4.

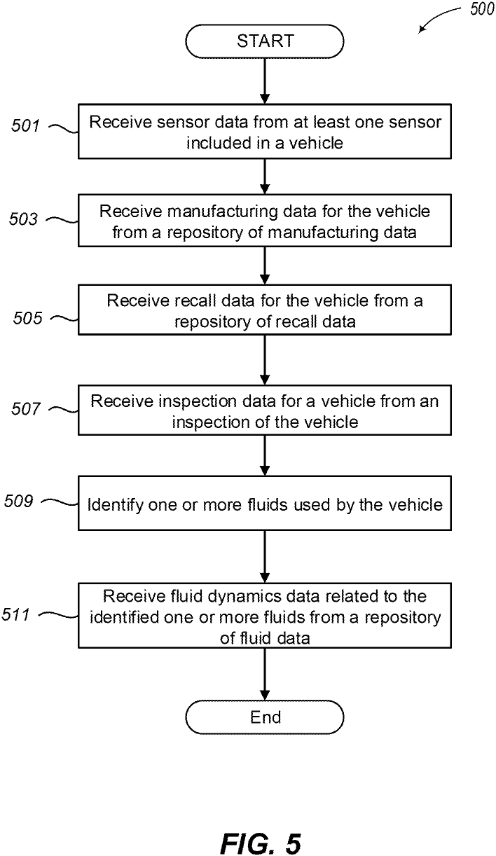

Process 300 continues at block 305, where the server periodically receives status data and fluid dynamics data for each vehicles in the plurality of vehicles. The server may receive the status data and fluid dynamics data by using the process 500 described below in connection with FIG. 5. In some embodiments, the server receives the status data and fluid dynamics data at pre-defined consistent time intervals, such as every minute, hour, day, second, or other time interval. In some embodiments, the server receives the status data and fluid dynamics data at various different times. In some embodiments, the server receives the status data in response to an inspection which is performed on the vehicle.

Process 300 proceeds next to block 307, where the server determines whether at least one vehicle of the plurality of vehicles is recommended to undergo maintenance based on the status data and the fluid dynamics data. The server may determine whether at least one vehicle is recommended to undergo maintenance by using one or more modules, such as the fleet maintenance identification manager module 231, fleet maintenance identification module 233, and maintenance recommendation module 235 described above in connection with FIG. 2.

Process 300 continues at block 309, where the server causes at least one vehicle to undergo the recommended maintenance. In some embodiments, the server causes the at least one vehicle to undergo the recommended maintenance by one or more of: indicating to an operator associated with the vehicle that the vehicle is recommended to undergo maintenance, causing one or more parts to be ordered for the vehicle, scheduling a time maintenance for the vehicle at a location equipped to provide the recommended maintenance, or other methods of causing a vehicle to undergo maintenance. In some embodiments, the server identifies a computing device associated with an operator of the vehicle and uses the computing device to display information indicating to the operator that the vehicle is recommended to undergo maintenance. In some embodiments, the server identifies one or more parts based on a determination that the vehicle is recommended to undergo maintenance, or a determination of the maintenance required for the vehicle, and the server causes at least a portion of the identified parts to be acquired for the vehicle. In some embodiments, the server uses a blockchain to cause the one or more identified parts to be ordered for the vehicle.

After block 309, the process 300 ends.

In some embodiments, the server does not receive fluid dynamics data at block 305. In such embodiments, the server may determine whether at least one vehicle is recommended to undergo maintenance without using fluid dynamics data.

In some embodiments, the server determines whether at least one vehicle is recommended to undergo maintenance by applying the status data to a machine learning model trained to identify whether a vehicle is recommended to undergo maintenance based on status data. In some embodiments, the server determines whether at least one vehicle is recommended to undergo maintenance by applying statistical analysis to the status data to determine whether a vehicle is recommended to undergo maintenance.

The server may determine one or more types of maintenance recommended for the vehicle at block 309. In some embodiments, the server determines the maintenance recommended for the vehicle by applying the status data and determination that the at least one vehicle requires maintenance to a machine learning model trained to use status data and a determination that maintenance is recommended for a vehicle to determine the maintenance recommended for the vehicle. In some embodiments, the server determines the maintenance recommended for the vehicle by applying statistical analysis to the status data to determine whether the maintenance recommended for the vehicle.

In some embodiments, the server includes historical status data describing the status of vehicles and when the vehicles underwent maintenance. In such embodiments, the server may add the status data and determination of whether the vehicle is recommended to undergo maintenance to the historical status data. The historical status data is used to train the machine learning model, or perform statistical analysis, to determine whether the vehicle is recommended to undergo maintenance. In embodiments where the recommended maintenance is identified for the vehicle, the historical status data may be used to train a machine learning model, or perform statistical analysis, to determine the maintenance which is recommended for the vehicle.

FIG. 4 illustrates a logical flow diagram showing one embodiment of a process 400 for identifying a plurality of vehicles within a fleet of vehicles.

After a start block, the process 400 begins at 401 where the server receives vehicle data for each vehicle in a fleet of vehicles. The vehicle data may include data identifying a vehicle, such as a make, model, type of vehicle, serial number, or other data used to identify a vehicle. The vehicle data may include data identifying one or more parts, such as, a type of part, a brand of the part, a model of the part, or other data used to identify a part.

Process 400 proceeds next to block 403, where the server identifies one or more types of parts included in each vehicle of the fleet of vehicles based on the vehicle data. The server may identify the parts based on one or more of: a brand of the part, a model of the part, a type of the part, or other information used to identify a part of a vehicle.

Process 400 continues at block 405, where the server identifies a plurality of vehicles included in the fleet of vehicles based on a type of part. In some embodiments, the plurality of vehicles each include the common type of part. In some embodiments, the plurality of vehicles do not each include the common type of part. In some embodiments, the plurality of vehicles include parts which are similar to the common type of part. The server may determine that a part is similar to the common type of part based on one or more of: the function of the part, the brand of the part, the model of the part, or other information used to identify a part of a vehicle.

After block 405, the process 400 ends.

FIG. 5 illustrates a logical flow diagram showing one embodiment of a process 500 for obtaining status data for a vehicle.

After a start block, process 500 begins at block 501, where the server receives sensor data from at least one sensor included in a vehicle. In some embodiments, the received sensor data is similar to the sensor data received from sensors 130a-130n described above in connection with FIG. 1A.

Process 500 proceeds to block 503, where the server receives manufacturing data for the vehicle from a repository of manufacturing data. In some embodiments, the repository of manufacturing data is similar to the manufacturer data repository 126 described above in connection with FIG. 1A and FIG. 2.

Process 500 continues to block 505, where the server receives recall data for the vehicle from a repository of recall data. In some embodiments, the repository of recall data is similar to the recall data repository 128 described above in connection with FIG. 1A and FIG. 2.

Process 500 proceeds next to block 507, where the server receives inspection data for a vehicle from an inspection of the vehicle. In some embodiments, the server receives the inspection data following an inspection of the vehicle. In some embodiments, the server receives the inspection data from a repository of inspection data, such as the inspection data repository 122 described above in connection with FIG. 1A and FIG. 2.

Process 500 continues to block 509, where the server identifies one or more fluids used by the vehicle. In some embodiments, the server identifies the one or more fluids based on one or more of: manufacturing data, such as the data received in block 503; vehicle data, such as the data received in block 401; and other data usable to identify one or more fluids used by the vehicle.

Process 500 proceeds next to block 511, where the server receives fluid dynamics data related to the one or more fluids from a repository of fluid data, such as the fluid dynamics data repository 124 described above in connection with FIG. 1A and FIG. 2.

After block 511, the process ends.

In some embodiments, the status data does not include all of the data received in the process 500. For example, the status data may include at least one of: sensor data, manufacturing data, recall data, inspection data, or fluid dynamics data. Thus, the status data need not include all of the data described in the process 500, and some aspects of the process 500 may be optional based on the type of data included in the status data.

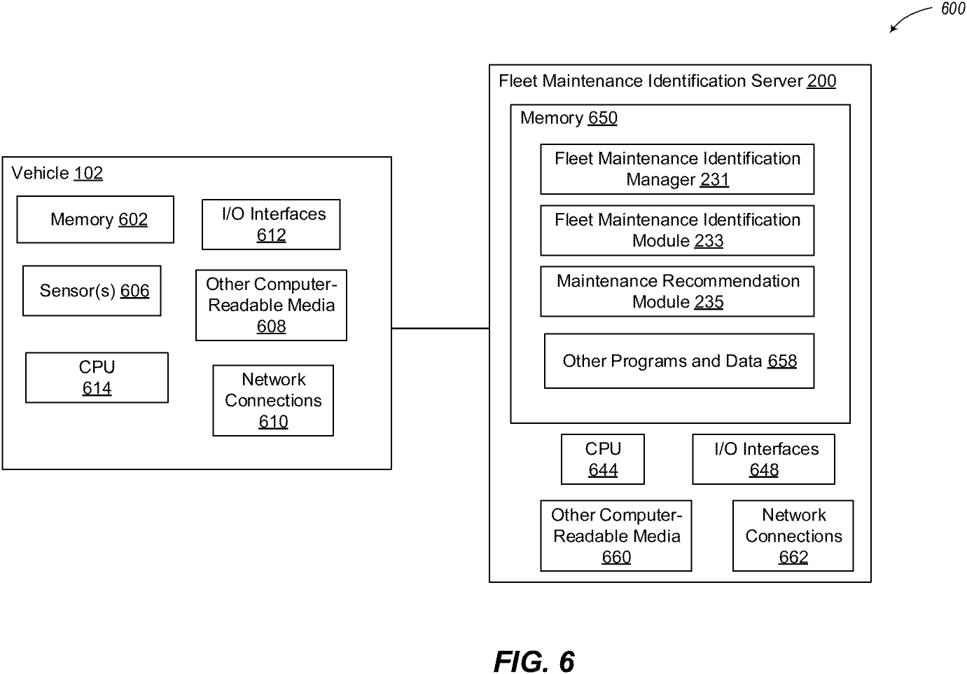

FIG. 6 shows a system diagram that describes various implementations of computing systems for implementing embodiments described herein. System 600 includes a fleet maintenance identification server 200 and a vehicle 102, which may communicate with one another via network 110.

The fleet maintenance identification server 200 receives vehicle data from the vehicle 102, such as status data, sensor data, or other data transmitted by the vehicle 102. The fleet maintenance identification server 200 may transmit instructions to one or more computing devices associated with the vehicle 102. The fleet maintenance identification server 200 may analyze the vehicle data along with other status data for the vehicle to determine whether the vehicle is recommended to undergo maintenance. One or more special-purpose computing systems may be used to implement the fleet maintenance identification server 200. Accordingly, various embodiments described herein may be implemented in software, hardware, firmware, or in some combination thereof. The fleet maintenance identification server 200 may include memory 650, one or more central processing units (CPUs) 644, I/O interfaces 648, other computer-readable media 660, and network connections 662.

Memory 650 may include one or more various types of non-volatile and/or volatile storage technologies. Examples of memory 650 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. Memory 650 may be utilized to store information, including computer-readable instructions that are utilized by CPU 644 to perform actions, including embodiments described herein.

Memory 650 may have stored thereon a fleet maintenance identification manager 231, fleet maintenance identification module 233, maintenance recommendation module 235, and other programs and data 658. The fleet maintenance identification manager 231, fleet maintenance identification module 233, and maintenance recommendation module 235 are each described above in connection with FIG. 2. The other programs and data 658 may include status data, such as the status data 201 described above in connection with FIG. 2.

Although the fleet maintenance identification manager 231, fleet maintenance identification module 233, and maintenance recommendation module 235 are illustrated as separate components, embodiments are not so limited. Rather, one or more computing components or modules may be employed to perform the functionality of the fleet maintenance identification manager 231, fleet maintenance identification module 233, and maintenance recommendation module 235.

Memory 650 may also store other programs and data 658, which may include operating systems, status data, historical status data for one or more vehicles or vehicle fleets, sensor data, etc.

In various embodiments, the network connections 662 include transmitters and receivers (not illustrated) to send and receive data as described herein. I/O interfaces 648 may include a video or audio interfaces, other data input or output interfaces, or the like, which can be used to receive or output information to an administrator, among other actions. Other computer-readable media 660 may include other types of stationary or removable computer-readable media, such as removable flash drives, external hard drives, or the like.

The vehicle 102 is a vehicle which is associated with a fleet. The vehicle 102 may include one or more sensors, such as the sensor 606. The sensors may include onboard or off-board sensors tracking the current status of the vehicle, environmental conditions, the location of the vehicle, or other data related to the vehicle 102.

The vehicle includes memory, such as memory 602, which may store vehicle data, sensor data, and other programs or data related to the functioning of the vehicle.

The vehicle 102 includes a CPU 614, I/O interfaces 612, other computer-readable media 608, and network connections 610. The CPU 614 included in the vehicle 102 may be similar to the CPU 644 included in the fleet maintenance identification server 200. The I/O interfaces 612 included in the vehicle 102 may be similar to the I/O interfaces 648 included in the fleet maintenance identification server 200. The other computer-readable media 608 included in the vehicle 102 may be similar to the other computer-readable media 660 included in the fleet maintenance identification server 200. The network connections 610 included in the vehicle 102 may be similar to the network connections 662 included in the fleet maintenance identification server 200.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method comprising:
receiving vehicle data describing vehicles in a fleet, the vehicle data describing at least one type of part for each vehicle in the fleet of vehicles;
identifying, based on the vehicle data, a type of part that is common to and thus included in each of a plurality of vehicles included in the fleet of vehicles;
identifying, based on the identified common type of part, vehicles from the fleet of vehicles that are in the plurality of vehicles;
periodically receiving status data for each vehicle of the plurality of vehicles, wherein, the status data includes sensor data, manufacturing data, recall data, inspection data;
identifying one or more fluids used by each vehicle of the plurality of vehicles;
receiving fluid dynamics data related to the identified one or more fluids;
determining, based on the a combination of each of the sensor data, the manufacturing data, the recall data, the inspection data, and the fluid dynamics data, whether at least one vehicle of the plurality of vehicles is recommended to undergo a selected maintenance;
for each vehicle that is recommended to undergo maintenance causing the recommended vehicles to undergo the selected maintenance.

2. The method of claim 1, wherein the status data is received periodically after each time period of a plurality of determined time periods.

3. The method of claim 1, wherein identifying the plurality of vehicles further comprises:
identifying, based on a determination that each vehicle of the plurality of vehicles includes the common type of part, the plurality of vehicles from the fleet of vehicles.

4. The method of claim 1, wherein identifying the plurality of vehicles further comprises:
identifying, based on a determination that each vehicle of the plurality of vehicles does not include the common type of part, the plurality of vehicles from the fleet of vehicles.

5. The method of claim 1, wherein determining whether the at least one vehicle is recommended to undergo maintenance further comprises:
applying the sensor data, the manufacturing data, the recall data, the inspection data, and the fluid dynamics data to a machine learning model trained to identify whether a vehicle is recommended to undergo maintenance based on sensor data, manufacturing data, recall data, inspection data, and fluid dynamics data; and
obtaining, from the machine learning model, an indication of the at least one vehicle recommended to undergo maintenance.

6. The method of claim 1, wherein causing a vehicle to undergo the recommended maintenance further comprises:
determining the recommended maintenance based on the sensor data, manufacturing data, the recall data, the inspection data, and the fluid dynamics data.

7. The method of claim 6, wherein determining the recommended maintenance further comprises:
identifying, based on the determined recommended maintenance, one or more parts for the vehicle; and
automatically causing at least a portion of the identified parts to be acquired for the vehicle.

8. The method of claim 7, wherein the portion of the identified parts are automatically caused to be purchased by using a blockchain.

9. The method of claim 6, wherein determining the recommended maintenance further comprises:
applying the sensor data, the manufacturing data, the recall data, the inspection data, and the fluid dynamics data to a machine learning model trained to identify the recommended maintenance for a vehicle based on sensor data, manufacturing data, recall data, inspection data, and fluid dynamics data; and
obtaining, from the machine learning model, an indication of the recommended maintenance.

10. The method of claim 1, wherein automatically causing a vehicle to undergo the recommended maintenance comprises:
identifying a computing device associated with an operator of the vehicle; and
displaying, via the computing device, information indicating that the vehicle should undergo the recommended maintenance.

11. A computing device comprising:
a memory configured to store computer instructions; and
a processor configured to execute the computer instructions to:
receive vehicle data describing vehicles in a fleet, the vehicle data describing at least one type of part for each vehicle in the fleet of vehicles;
identify, based on the vehicle data, a type of part that is common to and thus included in each of a plurality of the vehicles included in the fleet of vehicles;
identify, based on the identified common type of part, a plurality of vehicles from the fleet of vehicles;
periodically receive status data for each vehicle in the plurality of vehicles from a plurality of different repositories, wherein each different repository of the plurality of different repositories stores different types of data associated with the plurality of vehicles;
determine, based on the status data, whether at least one vehicle of the plurality of vehicles is recommended to undergo maintenance; and
automatically cause the at least one vehicle to undergo the recommended maintenance.

12. The computing device of claim 11, wherein the processor determines whether the at least one vehicle is recommended to undergo maintenance by further executing the computer instructions to:
determine whether the at least one vehicle is recommended to undergo maintenance based on the status data by using a machine learning model trained to identify whether a vehicle is recommended to undergo maintenance based on status data; and
obtain, from the machine learning model, a determination that the at least one vehicle is recommended to undergo maintenance.

13. The computing device of claim 11, wherein the processor causes the at least one vehicle to undergo the recommended maintenance by further executing the computer instructions to:
determine the recommended maintenance based on the status data for the at least one vehicle.

14. The computing device of claim 13, wherein the processor determines the recommended maintenance by further executing the computer instructions to:
identify, based on the determined recommended maintenance, one or more parts for the at least one vehicle; and
automatically cause at least a portion of the identified parts to be acquired for the at least one vehicle.

15. The computing device of claim 13, wherein the processor determines the recommended maintenance by further executing the computer instructions to:
determine the recommended maintenance based on the status data by using a machine learning model trained to identify recommended maintenance for a vehicle based on status data; and
obtain, from the machine learning model, the recommended maintenance.

16. A non-transitory computer-readable medium storing computer instructions that, when executed by at least one processor, cause the at least one processor to perform actions, the actions comprising:
receiving vehicle data describing vehicles in a fleet of vehicles, the vehicle data describing at least one type of part for each vehicle in the fleet of vehicles;
identifying, based on the vehicle data, a type of part that is common to and thus included in each of a plurality of the vehicles included in the fleet of vehicles;
identifying, based on the identified common type of part, a plurality of vehicles from the fleet of vehicles;
receiving status data for each vehicle in the plurality of vehicles from a plurality of different repositories, wherein each different repository of the plurality of different repositories stores different types of data associated with the plurality of vehicles;
determining, based on the status data, whether at least one vehicle of the plurality of vehicles is recommended to undergo maintenance; and
automatically causing the at least one vehicle to undergo the recommended maintenance.

17. The computing device of claim 16, wherein determining whether the at least one vehicle is recommended to undergo maintenance by further comprises:
training a machine learning model to identify whether a vehicle is recommended to undergo maintenance based on status data; and
determining whether the at least one vehicle is recommended to undergo maintenance by applying the status data to the machine learning model.

18. The computing device of claim 11, wherein automatically causing the at least one vehicle to undergo the recommended maintenance further comprises:
determining the recommended maintenance based on the status data for the at least one vehicle.

19. The computing device of claim 18, wherein determining the recommended maintenance further comprises:
identifying, based on the determined recommended maintenance, one or more parts for the at least one vehicle; and
automatically causing at least a portion of the identified parts to be acquired for the at least one vehicle.

20. The computing device of claim 18, wherein determining the recommended maintenance further comprises:
training a machine learning model to identify recommended maintenance for a vehicle based on status data; and
determining the recommended maintenance by applying the status data to the machine learning model.
